(19) United States
(12) Patent Application Publication
(10) Pub. No.: US 2003/0067742 A1
(43) Pub. Date: Apr. 10, 2003

(54) Dual digital CD-ROM drive

(76) Inventors: Steel Su, Taipei (TW); Toon Jeow Foo, Singapore (SG)

Correspondence Address: ROSENBERG, KLEIN & LEE, 3458 ELLICOTT CENTER DRIVE-SUITE 101, ELLICOTT CITY, MD, 21043, US

(21) Appl. No.: 09/969,595

(22) Filed: Oct. 4, 2001

(51) Int. Cl. G06F 1/16

(52) U.S. Cl. 361/684

(57) ABSTRACT

A dual digital CD-ROM drive comprising a drive unit and a panel. The drive unit has a CD-ROM drive and an internal memory card read/write device that are integrated into a single drive unit. The panel has a related button/indicator, an adjusting button, a CD tray, and at least a memory card slot (or a memory card convert socket slot) located on the surface of the panel and corresponding to the internal memory card read/write device of the drive unit 11. The memory card slot is used for the combination of a memory card convert socket and for the insertion of various memory cards, such as SM (Smart Media), MMC (Multi Media Card), MSD (Memory Stick Duo), MS (Memory Stick), SD (Security Digital Card), CF (Compact Flash), MG (Magic Gate) and Micro Drive.

### BACKGROUND OF THE INVENTION

The present invention relates to a dual digital CD-ROM drive, particularly to a dual digital CD-ROM drive in which the CD-ROM drive integrates with a memory card read/write device into a single drive unit. At least a memory card slot or a memory card convert socket slot is designed in an appropriate position on a panel in the drive unit to combine the memory card convert socket and improve the data accessing function.

As for the data accessing operation of CD-ROM drives, a single drive unit can perform data accessing and transmission actions only for a single media, i.e. CD. This design is insufficient for computer systems that need multiplex operations. Though additional data accessing devices can be installed to gain additional functions, the costs for hardware may increase and the location of the installation or the space for the installation may not be suitable for the additional devices.

### SUMMARY OF THE INVENTION

The primary objective of the present invention is to provide a dual digital CD-ROM drive, which has an additional data accessing devices installed in the existing space of the drive unit to improve the data accessing function and make the CD-ROM drive more practical in application.

According to the present invention, the dual digital CD-ROM drive integrates with a memory card read/write device into a single drive unit. At least a memory card slot or a memory card convert socket slot is designed in an appropriate position on a panel in the drive unit to combine the memory card convert socket and access data of various memory cards.

In a preferred embodiment, the dual digital CD-ROM drive comprises a drive unit and a panel. The drive unit includes a CD-ROM drive that integrates with a memory card read/write device into a single drive unit. The panel has a related button/indicator, an adjusting button, a CD tray, and at least a memory card slot (or a memory card convert socket slot). These apparatus are located in an appropriate position on the panel and, together with the memory card convert socket, corresponding to the internal memory card read/write device of the drive unit for the insertion of various memory cards, such as SM (Smart Media), MMC (Multi Media Card), MSD (Memory Stick Duo), MS (Memory Stick), SD (Security Digital Card), CF (Compact Flash), MG (Magic Gate) and Micro Drive.

### BRIEF DESCRIPTION OF THE DRAWING

FIG. 1 is the embodiment of the dual digital CD-ROM drive, showing the slot for the memory card to be inserted on the panel;

FIG. 2 is another embodiment of the dual redundant digital CD-ROM drive, showing the slot for the memory card convert socket to be inserted on the panel.

### DETAILED DESCRIPTION OF THE PREFERRED EMBODIMENT

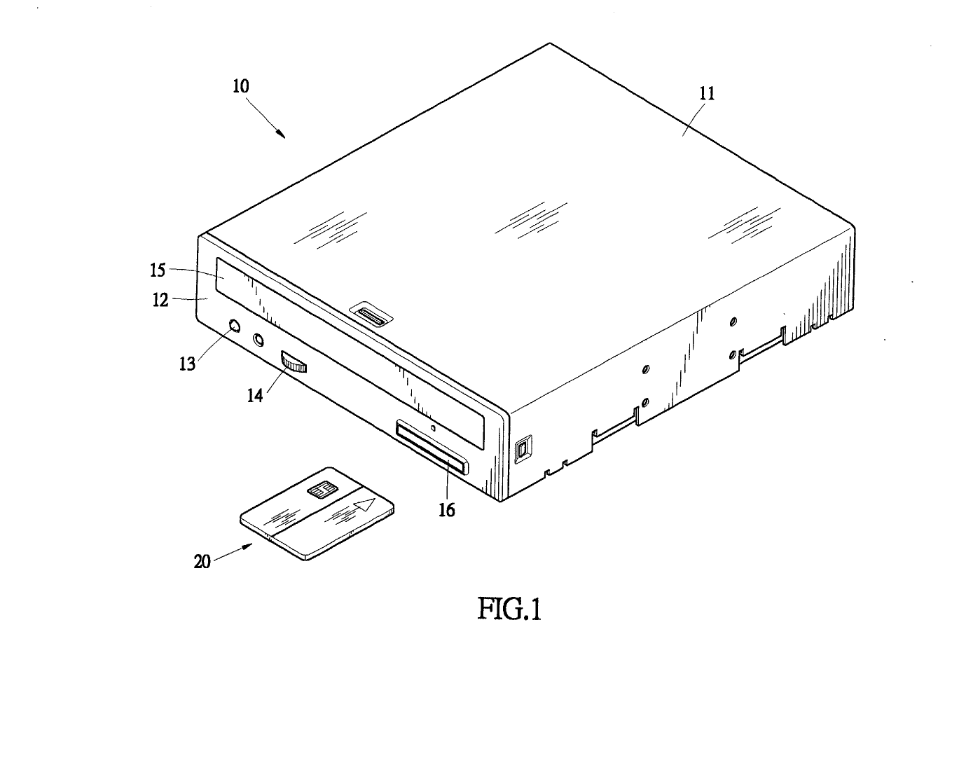

As shown in FIG. 1, the dual digital CD-ROM drive 10 comprises a drive unit 11 and a front panel 12 of the drive unit to form an appearance similar to that of conventional CD-ROM drives.

The drive unit 11 of the dual digital CD-ROM drive 10 has a CD-ROM drive and an internal memory card read/write device (not shown in the figures) that are integrated into a single drive unit.

The panel 12 has a related button/indicator 13, an adjusting button 14, a CD tray 15, and at least a memory card slot 16 located on the surface of the panel 12 and corresponding to the internal memory card read/write device of the drive unit 11. The memory card slot 16 is used for the insertion of an additional memory card 20 to provide an additional data accessing function for the CD-ROM drive.

The memory card 20 can be any type of media, such as SM (Smart Media), MMC (Multi Media Card), MSD (Memory Stick Duo), MS (Memory Stick), SD (Security Digital Card), CF (Compact Flash), MG (Magic Gate) and Micro Drive.

In addition to reading from and writing into CD via CD-ROM drive, the dual digital CD-ROM drive can accept the memory card 20 to be inserted into the memory card slot 16 to form an additional data accessing device. It is especially useful to complete the tasks in the multiplex operation environment commonly used nowadays.

Besides, the additional slot of the dual digital CD-ROM drive is installed in the existing space on the panel of the CD-ROM drive, without the need to change the appearance of the panel.

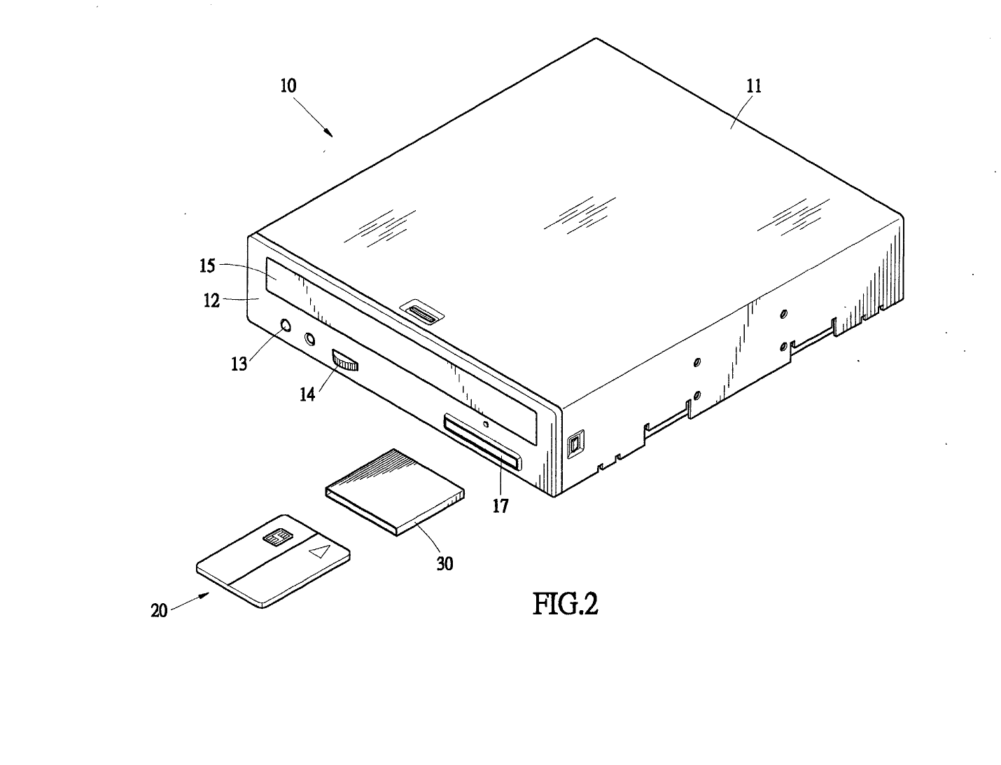

As shown in FIG. 2, the panel 12 has a related button/indicator 13, an adjusting button 14, a CD tray 15, and a memory card convert socket slot 17 located on the surface of the panel 12 and corresponding to the internal memory card read/write device of the drive unit 11. The memory card convert socket slot 17 is used for the insertion of a memory card convert socket 30, so that the memory card 20 can be inserted into the memory card convert socket 30 to improve the data accessing functionality of the CD-ROM drive 10.

From the above-mentioned description, it is understood that the dual digital CD-ROM drive integrates the CD-ROM drive and the memory card read/write device into a single drive unit. Using the existing space on the panel of the CD-ROM drive to place an additional slot, the dual digital CD-ROM drive provides an additional data accessing capability for the CD-ROM drive and improving its practicability significantly.

What is claimed is:

1. A dual digital CD-ROM drive, comprising:
a drive unit having a CD-ROM drive and an internal memory card read/write device integrated into a single drive unit;
a panel having a related button/indicator, an adjusting button, a CD tray, and at least a memory card slot on the surface of the panel and corresponding to the internal memory card read/write device of the drive unit; the memory card slot being used for the insertion of an additional memory card to improve the data accessing functionality of the CD-ROM drive.

2. The dual digital CD-ROM drive as claimed in claim 1, wherein the memory card comprises SM (Smart Media), MMC (Multi Media Card), MSD (Memory Stick Duo), MS (Memory Stick), SD (Security Digital Card), CF (Compact Flash), MG (Magic Gate) and Micro Drive.

3. The dual digital CD-ROM drive as claimed in claim 1, further comprising a memory card convert socket slot installed on surface of the panel and corresponding to the internal memory card read/write device of the drive unit for the insertion of a memory card convert socket with the memory card.
